(19) United States
(12) Patent Application Publication
(10) Pub. No.: US 2026/0300560 A1
(43) Pub. Date: Oct. 1, 2026

(54) DATA PROCESSING SYSTEM FOR TRUSTED COMPUTING

(71) Applicant: MUSE ELECTRONICS GMBH, Wien (AT)

(72) Inventor: Gerald ZACH, Obersdorf (AT)

(73) Assignee: MUSE ELECTRONICS GMBH, Wien (AT)

(21) Appl. No.: 19/489,351

(22) PCT Filed: Jun. 14, 2024
(86) PCT No.: PCT/AT2024/060230

§ 371 Date: Dec. 2, 2025

(30) Foreign Application Priority Data
Jun. 22, 2023 (AT) A 50493/2023

(51) Int. Cl. G06F 21/85; G06F 21/74; G06F 21/79

(52) U.S. Cl. CPC G06F 21/85; G06F 21/74; G06F 21/79

(57) ABSTRACT

A data processing system comprises a processor unit, at least two selectively connectable mass storage devices and either a trusted platform module having at least two switchable register banks or at least two switchable physical or virtual trusted platform modules. One of the register banks or one of the trusted platform modules is activated in accordance with the connected mass storage device or one of the trusted platform modules is connected together with the respective mass storage device.

### CROSS-REFERENCE TO RELATED APPLICATION/S

This application is a National Phase application of International Application No. PCT/AT2024/060230 filed Jun. 14, 2024 which claims priority to the Austrian Patent Application No. A 50493/2023 filed Jun. 22, 2023, the disclosures of which are incorporated herein by reference.

### TECHNICAL FIELD

The present disclosed subject matter relates to a data processing system comprising a central processor unit, which is powered by a power supply, at least two mass storage devices, either one of which is selectively connectable to the central processor unit via a first data bus, and a trusted platform module, which is connectable to the central processor unit via a second data bus.

### BACKGROUND ART

A data processing system comprising a trusted platform module (TPM) is also referred to as a trusted computing platform (TC platform). The TPM is a hardware or software element in accordance with the TPM specification, which is standardized by the Trusted Computing Group (TCG), most recently in the version TPM 2.0. In practice, the TPM is usually configured as a separate hardware chip, which is directly connected to the central processor unit via a separate data bus, for example a serial bus in accordance with the SPI (Serial Peripheral Interface), LPC (Low Pin Count), or i²C standards.

A TPM can be used for many security applications as part of the data processing system. For example, it provides a random number generator, cryptographic encryption algorithms, keys, and protected memory areas for encrypted data. In conjunction with mass storage devices, the TPM can for example be used for hardware-oriented encryption of the content of the mass storage devices. Alternatively, the TPM acts as a protected memory for encrypted hash values of snapshots of the hardware and/or of the operating system stored on the mass storage device when booting up the operating system, in order to verify its software integrity or ensure correct hardware assignment.

The use of the same data processing system with different operating systems which are stored on different mass storage devices, or with differently encrypted mass storage devices, is only possible with difficulty using the known solutions.

### BRIEF SUMMARY

The aim of the disclosed subject matter is to overcome these limitations and provide a data processing system which can provide mass storage device-based TPM services for use with different mass storage devices.

In a first embodiment of the disclosed subject matter, this aim is achieved by a data processing system of the type mentioned at the outset, which is characterized by a microcontroller, which is connectable to the second data bus, the trusted platform module having at least two register banks of platform configuration registers, of which only one register bank is active in an operating mode of the data processing system and the active register bank is settable by a control command received from the microcontroller, the microcontroller being configured to set the active register bank in accordance with the mass storage device selected for the operating mode by means of the control command in a configuration mode of the data processing system.

In this embodiment, the data processing system optionally comprises a changeover switch, which is settable by the microcontroller, is inserted into the second data bus, and connects the trusted platform module either to the central processor unit or to the microcontroller, the microcontroller being configured to connect the trusted platform module to the central processor unit in the operating mode and to the microcontroller in the configuration mode by means of the changeover switch.

In a second embodiment, the disclosed subject matter achieves this aim by means of a data processing system of the type mentioned at the outset, which is characterized by a microcontroller and a changeover switch, which is settable by the microcontroller, is inserted into the second data bus, and connects the central processor unit either to the first trusted platform module or to a second trusted platform module via the second data bus in an operating mode of the data processing system, the microcontroller being configured to set the changeover switch in accordance with the mass storage device selected for the operating mode in a configuration mode of the data processing system.

In a third embodiment, the disclosed subject matter provides a data processing system of the type mentioned at the outset, which is characterized by a microcontroller, which is connected to the second data bus and is configured to emulate each of the first trusted platform module and a second trusted platform module as a software instance, only one of these software instances being active in an operating mode of the data processing system in each case, the microcontroller being configured to set the active software instance in accordance with the mass storage device selected for the operating mode in a configuration mode of the data processing system.

In this embodiment, the two trusted platform modules of the second embodiment are implemented as software instances in the microcontroller, which simplifies the practical implementation.

In all three above-mentioned embodiments, it is

particularly advantageous for each mass storage device to be provided with a machine-readable identifier and for the microcontroller to be connected to a reader for reading identifiers and to be configured to detect the mass storage device selected for the operating mode on the basis of the identifier read by the reader.

The configuration mode is optionally an alternative to the operating mode, but could also be temporarily assumed in parallel with the operating mode.

In a fourth embodiment, the disclosed subject matter solves the above-mentioned problem by means of a data processing system of the type mentioned at the outset, which is characterized by a second trusted platform module, which is selectively connectable to the second data bus instead of the first trusted platform module, one of the mass storage devices and one of the trusted platform modules which is assigned to this mass storage device being arranged in a shared transport housing, which is detachably connected to the rest of the data processing system.

In each of the four above-mentioned embodiments, the data processing system according to the disclosed subject matter makes it possible to use different mass storage devices as desired, for example loaded with different operating systems or encrypted in a different way, in conjunction with the TPM service of a TPM individually configured for the respective mass storage device or individually configured platform configuration registers (PCRs) of a TPM.

By using a changeover switch, in the two first embodiments it can be ensured that the TPM always only communicates via the second data bus with one single component on the bus, such that communication disruption is prevented. Furthermore, this embodiment is particularly suitable for simple TPMS which are not equipped for multi-peer communication.

In the fourth embodiment, in which a TPM and a mass storage device are each combined in a separate housing that is connectable to the rest of the data processing system, another transport housing can alternatively simply be connected instead of switching a switch. The disclosed subject matter thus provides a new product, namely an interchangeable unit made up of a mass storage device and a TPM, which can be used interchangeably with the same central processor unit.

In the first three embodiments, it can optionally be provided that the power supply to the central processor unit is interrupted in the configuration mode. As a result, the central processor unit starts up after returning to the operating mode and thus restoring the power supply again, and boots up using the respectively connected mass storage device and assigned TPMs.

The first data bus can be configured in accordance with any prior art suitable for connecting mass storage devices that is known in the art. The first data bus is optionally configured in accordance with one of the standards USB, USB-C, Thunderbolt, SATA, eSATA, PCI, or PCIe.

The second data bus can also be configured in accordance with any standard suitable for connecting TPMs that is known in the art. The second data bus is optionally configured in accordance with one of the standards i2C, SPI, or LPC.

In all the above-mentioned embodiments, each of the mass storage devices is optionally a semiconductor hard disk or a non-volatile memory chip.

### BRIEF DESCRIPTION OF THE DRAWINGS/FIGURES

The disclosed subject matter will be explained in greater detail in the following with reference to exemplary embodiments shown in the accompanying drawings, in which:

FIG. 1 shows a first embodiment of the data processing system of the disclosed subject matter in a block diagram;

FIG. 2 shows a second and a third embodiment of the data processing system of the disclosed subject matter in a block diagram; and

FIG. 3 shows a fourth embodiment of the data processing system of the disclosed subject matter in a block diagram.

### DETAILED DESCRIPTION

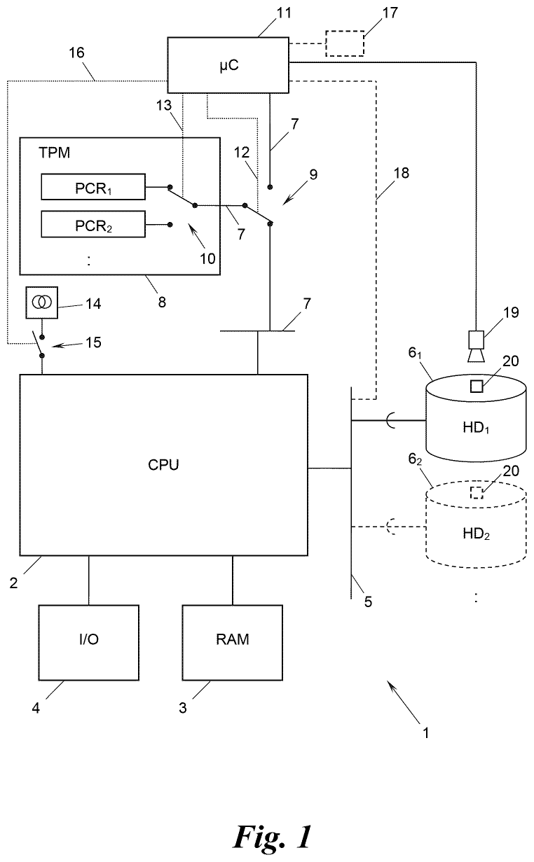

FIG. 1 shows a first embodiment of a data processing system 1. The data processing system 1 comprises a central processor unit 2, to which a working memory 3 and at least one input/output unit 4, e.g. a screen, a keyboard, a touch screen, a printer, a network adapter, and/or any input/output interface, are connected.

One of a plurality of mass storage devices 6₁, 6₂, etc., generally 6ᵢ, is selectively connectable to the central processor unit 2 via a first data bus 5 as desired. The mass storage devices 6ᵢ are in particular persistent mass storage devices, i.e. they store their content even without a power supply over a long period of time. Examples of such persistent mass storage devices are magnetic or optical hard disks, semiconductor hard disks, or non-volatile memory chips such as flash RAMs, ROMS, PROMs, EPROMS, EEPROMs, SSDs (solid state disks), etc. The first data bus 5 can be configured in accordance with a standard suitable for such a mass storage device 6ᵢ, for example in accordance with the standards USB, USB-C, Thunderbolt, SATA, eSATA, PCI, or PCIe.

A trusted platform module (TPM) 8 is connected to the central processor unit 2 via a second data bus 7, and specifically, in the example shown, via a changeover switch 9 which is inserted into the second data bus 7. The TPM 8 is a trusted platform module in accordance with a TPM standard by the Trusted Computing Group (TCG), for example in accordance with the TPM 1.2 or TPM 2.0 standard. The TPM 8 provides the data processing system 1 with standardized TPM services and, for this purpose, has at least one bank of platform configuration registers (PCR) for storing keys, hash values, etc., as can be stored or retrieved via the second data bus 7 (e.g. in an encrypted manner).

In the example shown here, the TPM 8 has two or more banks PCR₁, PCR₂, etc., generally PCRᵢ, of platform configuration registers. By means of an internal changeover switch 10 in the TPM 8, the register bank PCRᵢ used (or “active”) in each case in the operating mode of the data processing system 1, i.e. if the central processor unit 2 wants to communicate with the TPM 8 via the data bus 7, can be selected.

The data processing system 1 comprises a microcontroller 11 to set the changeover switches 9 and 10. The microcontroller 11 is either always connected to the second data bus 7 or, as in the example shown, can alternatively be connected to the TPM 8 instead of the central processor unit 2 via the changeover switch 9. In the operating mode of the data processing system 1 shown in FIG. 1, where present, the changeover switch 9 is in the lower switch position shown, such that the microcontroller 11 is disconnected from the second data bus 7 and is inactive. If, however, a changeover switch 9 is not used, i.e. both the microcontroller 11 and the TPM 8 are connected to the second data bus 7 of the central processor unit 2, any communication on the second data bus 7 is avoided in the microcontroller 11 in the operating mode of the data processing system 1, so as not to disrupt the communication between the TPM 8 and the central processor unit 7.

In addition to or in particular as an alternative to its operating mode, the data processing system 1 can be put into a special configuration mode. If there is a changeover switch 9, the changeover switch 9 is then put into its upper position in FIG. 1 and thus the TPM 8 is connected to the microcontroller 11 via the second data bus 7. The microcontroller 11 itself can initiate the changeover switching of the changeover switch 9; see control path 12.

In the configuration mode, the microcontroller 11 sends a control command 13 to the TPM 8 via the second data bus 7 in order to set the TPM-internal changeover switch 10 (see the control path indicated by the dotted line) so as to thus select one of the PCR register banks PCRᵢ in the TPM 8 as the “active” register bank for continued operation. After leaving the configuration mode and re-entering the operating mode, i.e. after putting the changeover switch 9 into the lower position shown in FIG. 1, if it is present, or after avoiding any further communication by the microcontroller 7 on the data bus 7, the selected register bank PCRᵢ is then used again by the central processor unit 2. The central processor unit 2 does not notice that the active PCR register bank PCRᵢ in the TPM 8 has changed. If a changeover switch 9 is not used, the configuration mode can also be assumed just temporarily during the operating mode.

Optionally, in the configuration mode, a power supply 14 powering the central processor unit 2 can be interrupted by the microcontroller 11 via a controllable switch 15 and a corresponding control path 16. As a result of this, too, exclusive communication between the microcontroller 11 and the TPM 8 in the configuration mode can be achieved, in particular if a changeover switch 9 is not provided.

The microcontroller 11 is programmed such that it initiates the selection of the respective register bank PRCᵢ by controlling the changeover switch 10 depending on the mass storage device 6ᵢ that has just been connected to the first data bus 5. For example, the microcontroller 11 sets the first register bank PCR₁ for the first mass storage device 6₁, sets the second register bank PCR₂ for the second mass storage device 6₂, etc.

The information regarding which mass storage device 6ᵢ is connected or should be connected to the first data bus 5 in the operating mode can be obtained by the microcontroller 11 via an input apparatus 17, for example, i.e. the user both connects the respective mass storage device 61 to the data bus 5 and accordingly sets the microcontroller 11 via the input apparatus 17. Alternatively, the microcontroller 11 can obtain this information automatically from the first data bus 5 via a corresponding data connection 18. Another option is for the microcontroller 11 to be connected to a reader 19, which reads out a corresponding identification 20 of the respective mass storage device 6ᵢ. The identification 20 can for example be a bar code, an RFID tag, or the like, which is affixed to or in the mass storage device 6ᵢ. For this purpose, the reader 19 can be a corresponding bar-code reader, RFID reader, or the like. The identification 20 can, however, also be stored in a special portion or module of the mass storage device 6ᵢ which can be read out by the reader 19, for example; the reader 19 can then be a corresponding interface, for example.

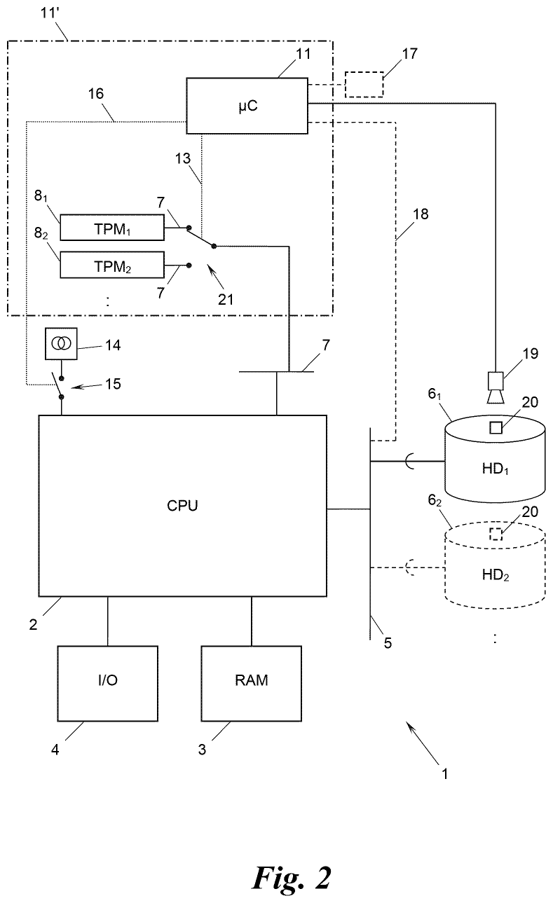

FIG. 2 shows a second and a third embodiment of the data processing system 1, with only the differences from the embodiment of FIG. 1 being discussed here. Instead of a single TPM 8, the data processing system 1 has a plurality of TPMs 8₁, 8₂, etc., generally 8ᵢ.

In the second embodiment, the different TPMs 8: are physical units and can alternatively be connected to the central processor unit 2 as desired via a changeover switch 21 inserted into the second data bus 7. The microcontroller 11 is then programmed such that, in the configuration mode, it connects each TPM 8ᵢ assigned to a mass storage device 6ᵢ to the central processor unit 2 via the changeover switch 21 and the data bus 7. Everything else, such as the selection or identification of the mass storage device 6ᵢ used in the operating mode by the microcontroller 11 for the purposes of controlling the changeover switch 21, takes place in the same way as in the embodiment of FIG. 1 for controlling the TPM-internal changeover switch 10.

In the third embodiment, the TPMs 8ᵢ are implemented as software instances in the programming of the microcontroller 11, as symbolized by the dash-dotted box 11′. The changeover switch 21 is accordingly also a software component in the programming of the microcontroller 11. It goes without saying that such software instances can also be implemented in firmware used for the programming of the microcontroller 11. The microcontroller 11 is then programmed such that, in the configuration mode, it sets the TPM 8ᵢ assigned to the respective mass storage device 6ᵢ and connects it to the data bus 7 via the software changeover switch 21. Everything else, such as the selection or identification of the mass storage device 6ᵢ used in the operating mode by the microcontroller 11 for the purposes of controlling the changeover switch 11 and setting the corresponding emulated TPMs 8ᵢ, again takes place in the same way as in the embodiment of FIG. 1 for controlling the TPM-internal changeover switch 10.

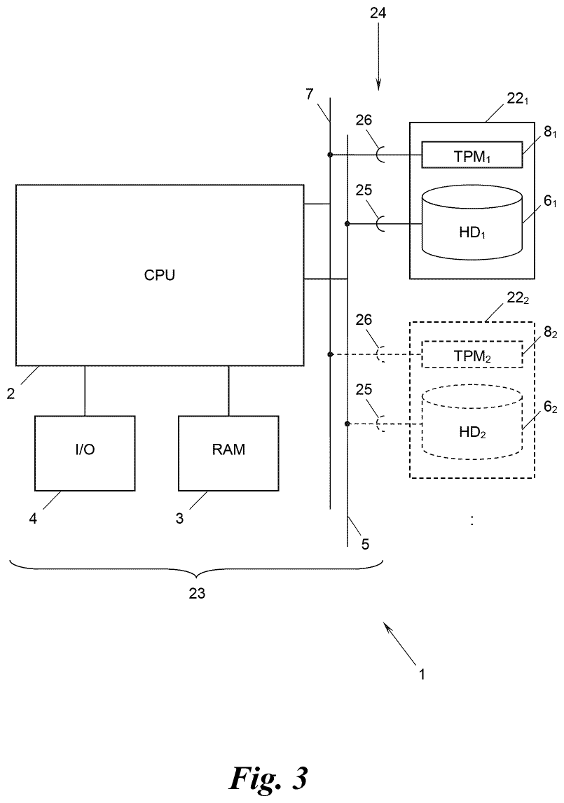

FIG. 3 shows a fourth embodiment of the data processing system 1, which manages without the changeover switches 10 and/or 21 for selecting between different register banks PCRᵢ of a TPM 8 or between different TPMs 8ᵢ. In FIG. 3, each TPM 8ᵢ is arranged together with the mass storage device 6: assigned to it in a separate transport housing 22₁, 22₂, etc., generally 22ᵢ. Each transport housing 22ᵢ can be detachably connected to the remaining part 23 of the data processing system 1, and specifically via an interface 24 which comprises, per transport housing 22ᵢ, a first interface 25 for detachably connecting to the first data bus 5 and a second interface 26 for detachably connecting to the second data bus 7.

The transport housing 22ᵢ can, for example, be the housing of a memory stick or an SSD, which has the further interface 26 for the integrated TPM 8ᵢ in addition to the mass storage device interface 25 for the mass storage device 6ᵢ.

In this fourth embodiment, the TPM 8ᵢ can again be emulated as a software instance by a microcontroller in the mass storage device 6ᵢ, if desired. It goes without saying that such software instances can also be implemented as firmware of the microcontroller.

The data processing system 1 can be configured in any form and for any purpose, for example as a server, terminal, computer, notebook, laptop, PDA (personal digital assistant), smartphone, or the like.

The disclosed subject matter is not limited to the exemplary embodiments set out, but instead covers all the variants, modifications, and the combinations thereof that fall within the scope of the accompanying claims.

What is claimed is:

1. A data processing system, comprising
a central processor unit, which is powered by a power supply,
at least two mass storage devices either one of which is selectively connectable to the processor unit via a first data bus,
a trusted platform module, which is connectable to the processor unit via a second data bus, and
a microcontroller which is connectable to the second data bus,
the trusted platform module having at least two register banks of platform configuration registers, of which only one register bank is active in an operating mode of the data processing system and the active register bank is settable by a control command received from the microcontroller,
the microcontroller being configured to set the active register bank in accordance with the mass storage device selected for the operating mode by means of the control command in a configuration mode of the data processing system.

2. The data processing system according to claim 1, further comprising a changeover switch, which settable by the microcontroller, is inserted into the second data bus, and connects the trusted platform module either to the processor unit or to the microcontroller,
the microcontroller being configured to connect the trusted platform module to the processor unit in the operating mode and to the microcontroller in the configuration mode by means of the changeover switch.

3. A data processing system, comprising
a central processor unit, which is powered by a power supply,
at least two mass storage devices, either one of which is selectively connectable to the processor unit via a first data bus,
a first trusted platform module, which is connectable to the processor unit via a second data bus,
a microcontroller and
a changeover switch, which settable by the microcontroller, is inserted into the second data bus, and connects the processor unit either to the first trusted platform module or to a second trusted platform module via the second data bus in an operating mode of the data processing system,
the microcontroller being configured to set the changeover switch-(21) in accordance with the mass storage device selected for the operating mode in a configuration mode of the data processing system.

4. A data processing system, comprising
a central processor unit which is powered by a power supply,
at least two mass storage devices, either one of which is selectively connectable to the processor unit via a first data bus,
a first trusted platform module, which is connectable to the processor unit via a second data bus, and
a microcontroller, which is connected to the second data bus and is configured to emulate each of the first trusted platform module and a second trusted platform module as a software instance, only one of these software instances being active in an operating mode of the data processing system in each case,
the microcontroller being configured to set the active software instance in accordance with the mass storage device selected for the operating mode in a configuration mode of the data processing system.

5. The data processing system according to claim 1, wherein each mass storage device is provided with a machine-readable identifier and the microcontroller is connected to a reader for reading identifiers and is configured to detect the mass storage device selected for the operating mode on the basis of the identifier read by the reader.

6. The data processing system according to claim 1, wherein the configuration mode is alternative to the operating mode.

7. The data processing system according to claim 1, wherein the power supply to the central processor unit is interrupted in the configuration mode.

8. A data processing system, comprising
a central processor unit,
at least two mass storage devices, either one of which is selectively connectable to the processor unit via a first data bus,
a first trusted platform module, which is connectable to the processor unit via a second data bus, and
a second trusted platform module, which can alternatively be connected to the second data bus instead of the first trusted platform module,
one of the mass storage devices and one of the trusted platform modules which is assigned to this mass storage device being arranged in a shared transport housing, which is detachably connected to the rest of the data processing system.

9. The data processing system according to claim 1, wherein the first data bus is configured in accordance with one of the standards USB, USB-C, Thunderbolt, SATA, eSATA, PCI, or PCIe.

10. The data processing system according to claim 1, wherein the second data bus is configured in accordance with one of the standards i2C, SPI, or LPC.

11. The data processing system according to claim 1, wherein each of the mass storage devices is a semiconductor hard disk or a non-volatile memory chip.

12. The data processing system according to claim 3, wherein each mass storage device is provided with a machine-readable identifier and the microcontroller is connected to a reader for reading identifiers and is configured to detect the mass storage device selected for the operating mode on the basis of the identifier read by the reader.

13. The data processing system according to claim 3, wherein the configuration mode is alternative to the operating mode.

14. The data processing system according to claim 3, wherein the power supply to the central processor unit is interrupted in the configuration mode.

15. The data processing system according to claim 4, wherein each mass storage device is provided with a machine-readable identifier and the microcontroller is connected to a reader for reading identifiers and is configured to detect the mass storage device selected for the operating mode on the basis of the identifier read by the reader.

16. The data processing system according to claim 4, wherein the configuration mode is alternative to the operating mode.

17. The data processing system according to claim 4, wherein the power supply to the central processor unit is interrupted in the configuration mode.

18. The data processing system according to claim 3, wherein each of the mass storage devices is a semiconductor hard disk or a non-volatile memory chip.

19. The data processing system according to claim 4, wherein each of the mass storage devices is a semiconductor hard disk or a non-volatile memory chip.

20. The data processing system according to claim 8, wherein each of the mass storage devices is a semiconductor hard disk or a non-volatile memory chip.
